(19) United States
(12) Patent Application Publication
(10) Pub. No.: US 2006/0010776 A1
(43) Pub. Date: Jan. 19, 2006

(54) Window-lifting device

(76) Inventor: Stefan Jutzi, Sindelfingen (DE)

Correspondence Address: KENYON & KENYON, ONE BROADWAY, NEW YORK, NY, 10004, US

(21) Appl. No.: 11/173,489

(22) Filed: Jul. 1, 2005

(30) Foreign Application Priority Data
Jul. 1, 2004 (DE) 10 2004 031 804.2

(51) Int. Cl. B60J 1/16

(52) U.S. Cl. 49/375

(57) ABSTRACT

A window-lifting device, e.g., for a motor-vehicle door, includes at least one carrier for connecting a window pane to a window lifter, the carrier being movably supported on at least one guide rail, and an adjustment device being provided for changing the inclination of the window pane relative to the guide rail, about a swivel axis. The carrier is movably supported directly on the guide rail in the region of the swivel axis, and, in order to change the inclination of the window pane, the adjustment device is arranged to change the inclination of the carrier relative to the guide rail, about the swivel axis.

### CROSS-REFERENCE TO RELATED APPLICATIONS

The present application claims priority to Application No. 10 2004 031 804.2, filed in the Federal Republic of Germany on Jul. 1, 2004, which is expressly incorporated herein in its entirety by reference thereto.

### FIELD OF THE INVENTION

The present invention relates to a window-raising device, e.g., for a motor-vehicle door.

### BACKGROUND INFORMATION

In modern motor-vehicle manufacturing, so-called frameless doors are used in many places, where, in the closed state and when a side door is closed, a side window lies directly against a gasket of a vehicle body. In contrast to a door having a frame, where the side window is guided in the frame and is bordered by it, and where the sealing takes place between the frame and the body shell, in the case of the frameless door the side window must press with a certain force against the gasket of the vehicle body in the closed state and when the vehicle door is closed, in order to reliably ensure the sealing action. This is often accomplished in that the side window is slightly prestressed in the direction of the gasket and therefore generates the necessary contact pressure for the body-shell gasket.

German Published Patent Application No. 198 19 953 describes an adjustable carrier for connecting a window pane to a window lifter of a motor-vehicle door, the carrier being movably supported on at least one guide rail and being assigned or attached to the motor-vehicle door by it. In this context, the carrier is essentially made up of a base and a receiving member, the base being guided on the guide rail of the window lifter, and the window pane being held on the receiving member. In order to be able to prestress the window pane in the direction of the body-shell gasket, the receiving member is designed to swivel with respect to the base and an articulated joint is provided between these two. An adjusting device, e.g., screws, are provided for changing the position of the receiving member with respect to the base. However, the position of the base with respect to the guide rail remains the same.

German Published Patent Application No. 101 45 180 describes an adjustable carrier for connecting a window pane to a motor-vehicle window lifter, the carrier having a base guided on a guide rail of the window lifter and a receiving member for accommodating a window pane. The receiving member is connected to the base by a joint, so as to be able to swivel. In order to be able to exactly position the receiving member with respect to the base and therefore fix the orientation of the window pane, a locking device is provided, which, in response to initial stress generated by, e.g., a compression spring, acts on the receiving member or is mechanically linked to it such that, in the event of the receiving member being swiveled with respect to the base, device is moved into a position, in which it blocks the receiving member from swiveling back in the opposite direction and thereby maintains the previously set position of the window pane. The carrier is also made up of a base and a receiving member that is adjustable relative to it.

German Published Patent Application No. 199 43 717 describes a window lifter for adjusting a window pane of a motor vehicle, the window pane being supported in a receiving region of a carrier. The receiving region has a contact surface, against which the outer surface of the window pane rests, as well as a device that allows window panes of varied thickness to be accommodated. To this end, the position of the carrier contact surface at right angles to the plane of the pane may be set independently of the thickness of the window pane, using the above-mentioned device.

### SUMMARY

An example embodiment of the present invention may provide a window-lifting device that may provide for simple and reliable adjustability of the inclination of the window pane, e.g., using a structurally simple design approach.

In the case of a window-lifting device, e.g., for a motor-vehicle door, having at least one carrier which is used for connecting a window pane to a window lifter and is movably supported on at least one guide rail, and having an adjustment device for changing the inclination of the window panes relative to the guide rail about a swivel axis, an example embodiment of the present invention includes movably supporting the carrier directly on the guide rail, in the region of the swivel axis, and also arranging the adjustment device to change the inclination of the carrier relative to the guide rail about the swivel axis in order to change the inclination of the window pane.

In contrast to conventional arrangements, in which the carrier is made up of a base guided on the guide rail and a receiving member that can swivel with respect to it, the arrangement hereof may eliminate this bipartition of the carrier, the change in the inclination of the window pane being accomplished by directly changing the inclination of the carrier relative to the guide rail, about the swivel axis. In this manner, the increased assembly expenditure that may have been previously necessary may be eliminated, which means that the carrier hereof may aid in reducing the production and processing costs. The carrier hereof may allow the inclination of the window pane to be adjusted in an exact, continuous manner and, in this manner, may ensure a particularly high manufacturing quality. Furthermore, the nearly one-piece construction of the carrier hereof may allow the storage and logistical costs necessary for a carrier of a conventional construction type (multisectional) to be reduced.

The carrier is movably supported on the guide rail, directly via a supporting element, at a distance from the swivel axis, the distance of the carrier to the guide rail being adjustable with the aid of the adjustment device in the region of the supporting element. In this connection, the supporting element may take the form of, e.g., a sliding member, and as a result, it is guided on the guide rail with little friction. The positioning of the supporting element on the carrier, at a distance from the swivel axis, e.g., on a lower edge of the carrier in the mounted state, may allow the inclination angle of the carrier with respect to the guide rail, and therefore the inclination angle of the window pane, to be adjusted in a simple and precise manner. In particular, the exact adjustment of the inclination angle of the window pane may be indispensable for providing subsequent, reliable sealing between the window pane and a body-shell gasket. The described configuration of the supporting element may provide a stable, three-point support of the carrier on the guide rail, two support points being located in the region of the swivel axis.

According to an example embodiment of the present invention, at least one screw and/or at least one threaded bolt may be provided as an adjustment device. Presently, nearly all types of high-quality screws and threaded bolts may be inexpensively manufactured and may also allow exact adjustment and positioning.

An example embodiment of the present invention may provide for the carrier to have a retaining element for holding the window pane. Such retaining elements may have, for example, a hook-shaped arrangement and may embrace the window pane at an edge of the window pane and therefore support it. In contrast to conventional carriers, the retaining elements in the carrier hereof may be directly mounted to a side of the carrier opposite to the guide rail, and not to a receiving member pivoted at the base of the carrier. In this context, the retaining elements may be manufactured or injection-molded, together with the carrier, in one production step and, therefore, manufactured cost-effectively, e.g., without additional, subsequent expenditure for assembly.

According to an example embodiment of the present invention, a longitudinal axis of the adjustment device is inclined with respect to a line perpendicular to the guide rail. This slightly slanted configuration may allow easier access to the adjustment device and therefore may facilitate the alignment and adjustment of the inclination of the carrier or the window pane. For example, the longitudinal axis of the adjustment device may be adapted to subsequent possibilities for access, which means that maintenance and repair expense may be minimized.

According to an example embodiment of the present invention, a window-lifting device includes: at least one guide rail; at least one carrier adapted to connect a window pane to a window lifter; and an adjustment device adapted to change an inclination of the window pane relative to the guide rail about a swivel axis. The carrier is movably supported directly on the guide rail in a region of the swivel axis, and the adjustment device adapted to change an inclination of the carrier relative to the guide rail about the swivel axis to change the inclination of the window pane.

The window-lifting device may be adapted to be mounted in a motor-vehicle door.

The window-lifting device may include a support element. The carrier may be movably supported on the guide rail directly by the support element at a distance from the swivel axis, and the adjustment device may be adapted to adjust the distance of the carrier to the guide rail in a region of the support element.

The support element may be arranged at an edge of the carrier corresponding to a lower edge in an assembled state.

The adjustment device may include at least one of (a) at least one screw and (b) at least one threaded bolt.

The carrier may include retainer elements adapted to support the window pane.

The carrier may be supported on the guide rail by a three-point support, and the support element may correspond to one support point of the three-point support.

A longitudinal axis of the adjustment device may be inclined with respect to a line perpendicular to the guide rail.

The window-lifting device may include a carrier plate having cut-outs in a region of the retainer elements mounted to the carrier.

According to an example embodiment of the present invention, a window-lifting device includes: guide rail means; carrier means for connecting a window pane to a window lifter; and adjusting means for changing an inclination of the window pane relative to the guide rail means about a swivel axis. The carrier means is movably supported directly on the guide rail means in a region of the swivel axis, and the adjusting means is for changing an inclination of the carrier means relative to the guide rail means about the swivel axis to change the inclination of the window pane.

According to an example embodiment of the present invention, a motor-vehicle door includes: a window pane; a window lifter; and a window-lifting device. The window-lifting device includes: at least one guide rail; at least one carrier, the window pane connected to the window lifter by the carrier; and an adjustment device adapted to change an inclination of the window pane relative to the guide rail about a swivel axis. The carrier is movably supported directly on the guide rail in a region of the swivel axis, and the adjustment device adapted to change an inclination of the carrier relative to the guide rail about the swivel axis to change the inclination of the window pane.

Additional features and aspects of example embodiments of the present invention are described below with reference to the appended Figures.

It should be understood that the aforementioned features and those described below may be used not only in the combinations indicated but also in other combinations, or alone, without departing from the spirit and scope hereof.

Exemplary embodiments of the present invention are illustrated in the appended Figures and explained in more detail in the following description, where identical reference numerals refer to the same, functionally identical, or similar component parts.

### BRIEF DESCRIPTION OF THE DRAWINGS

FIG. 1 is a schematic view of a carrier of an example embodiment of the present invention on a guide rail.

FIG. 2 is a schematic rear view of a carrier according to an example embodiment of the present invention.

### DETAILED DESCRIPTION

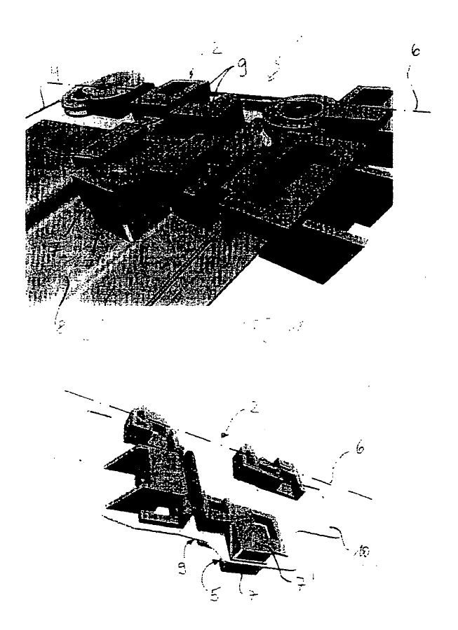

As illustrated in FIG. 1, a window-lifting device 1 of an example embodiment of the present invention includes a carrier 2, which is movably supported on a guide rail 3. In this context, carrier 2 is used for connecting a window pane to a window lifter. Carrier 2 is moved along the guide rail by movement device 4, e.g., a cable line, which produces a drive connection between carrier 2 and the window lifter. Window-lifting device 1 illustrated in FIG. 1 may be installed, for example, in a motor-vehicle door, and may be used for operating a side window of a motor vehicle.

In order to produce reliable sealing between the side window and a body-shell gasket of the motor vehicle in, e.g., a frameless door, the side window may be prestressed in the direction of the body-shell gasket, so that when the side window is closed and the vehicle door is closed, a sufficient contact pressure of the side window onto the body-shell gasket and, therefore, sufficient sealing action may be produced. The preloading of the side window in the direction of the body-shell gasket may be accomplished by lightly tilting the side window in the direction of the body-shell gasket, adjustment device 5 being provided for changing the inclination of the window pane relative to guide rail 3, about a swivel axis 6.

To this end, an example embodiment of the present invention may provide for carrier 2 to be movably supported directly on guide rail 3 in the region of swivel axis 6, and for adjustment device 5 to be arranged to change the inclination of carrier 2 relative to guide rail 3 about swivel axis 6, in order to change the inclination of the window pane.

To change the inclination of carrier 2, it is movably supported on guide rail 3, directly via a supporting element 7, at a distance from swivel axis 6, the distance of carrier 2 to guide rail 3 being adjustable by adjustment device 5 in the region of supporting element 7. By this device, carrier 2 is supported on guide rail 3 via a three-point support, supporting element 7 constituting one of the three support points. The two other support points are arranged in the region of swivel axis 6.

As is apparent from FIG. 1, guide rail 3 has a suitable guide profile, which allows carrier 2 to be reliably guided on guide rail 3. To this end, carrier 2 may, for example, embrace guide rail 3 or grip it from behind.

As illustrated in FIGS. 1 and 2, supporting element 7 has a part rigidly connected to carrier 2, as well as a part 7′ that is movable with respect to this part with the aid of adjustment device 5. For example, at least one screw and/or at least one threaded bolt, of which an angular movement changes the distance of carrier 2 to guide rail 3 in the region of supporting element 7, may be provided as adjustment device 5. As illustrated in FIG. 1, part 7′ of supporting element 7 facing guide rail 3 slides on a profile protuberance 8 of guide rail 3.

As illustrated in FIG. 1, a longitudinal axis of adjustment device 5 is inclined with respect to a line perpendicular to guide rail 3, which means that improved and easier access to adjustment device 5 may be ensured when window-lifting device 1 is built into the vehicle door. It is also possible for a longitudinal axis of adjustment device 5 to extend parallel to the line perpendicular to guide rail 3.

In order to hold the window pane on carrier 2, retaining elements 9 may be provided, as illustrated in FIG. 1, which may take the form of hooks. In this context, retaining elements 9 are arranged in the region of supporting element 7 and, therefore, on an edge of carrier 2 that is a lower edge in the installed state. If carrier 2 is also made of injection-molded plastic, it is possible for retaining elements 9 to be manufactured together with carrier 2 in one injection-molding operation, or to be subsequently injection-molded onto it or connected to it. Retaining elements 9 embrace an edge of the window pane, thereby fixing the position of the window pane and/or carrier 2.

Illustrated in FIG. 2 is a carrier plate 10, which is mounted to carrier 2 and has cut-outs in the region of retaining elements 9, retaining elements 9 protruding through the cut-outs. Therefore, in the final assembled state, one side of the window pane rests against carrier plate 10 and is embraced by hook elements 9 on the edge, which means that on the side opposite to carrier plate 10, the window pane rests against the hook end of retaining elements 9.

In comparison with conventional carriers, carrier 2 hereof may have markedly fewer component parts, which means that production, storage, and logistical costs may be reduced. In addition, the window pane may be inclined in a structurally simple manner by inclining carrier 2 with respect to guide rail 3, so that reliable sealing between the window pane and the body-shell gasket of the motor vehicle may be ensured. Furthermore, the elimination of component parts that may have been conventionally necessary may allow a reduction in weight, which means that the arrangement hereof may additionally contribute towards saving energy.

In summary, features hereof may include:

In the case of a window-lifting device 1 having at least one carrier 2 that is movably supported on a guide rail 3, and having an adjustment device 5 for changing the inclination of the window pane relative to guide rail 3, about a swivel axis 6, carrier 2 may be movably supported directly on guide rail 3 in the region of swivel axis 6, and adjustment device 5 may be arranged to change the inclination of carrier 2 relative to guide rail 3 about swivel axis 6 in order to change the inclination of the window pane.

Thus, the inclination of the window pane may be changed by directly changing the inclination of carrier 2 with respect to guide rail 3, which means that arrangement may be provided that may be structurally simple in comparison with conventional solutions, where carrier 2 is made up of a base plate and a receiving plate. In particular, cost advantages may be realized in the production of window-lifting device 1.

What is claimed is:

1. A window-lifting device, comprising:
at least one guide rail;
at least one carrier adapted to connect a window pane to a window lifter; and
an adjustment device adapted to change an inclination of the window pane relative to the guide rail about a swivel axis;
wherein the carrier is movably supported directly on the guide rail in a region of the swivel axis, the adjustment device adapted to change an inclination of the carrier relative to the guide rail about the swivel axis to change the inclination of the window pane.

2. The window-lifting device according to claim 1, wherein the window-lifting device is adapted to be mounted in a motor-vehicle door.

3. The window-lifting device according to claim 1, further comprising a support element, the carrier movably supported on the guide rail directly by the support element at a distance from the swivel axis, the adjustment device adapted to adjust the distance of the carrier to the guide rail in a region of the support element.

4. The window-lifting device according to claim 3, wherein the support element is arranged at an edge of the carrier corresponding to a lower edge in an assembled state.

5. The window-lifting device according to claim 1, wherein the adjustment device includes at least one of (a) at least one screw and (b) at least one threaded bolt.

6. The window-lifting device according to claim 1, wherein the carrier includes retainer elements adapted to support the window pane.

7. The window-lifting device according to claim 3, wherein the carrier is supported on the guide rail by a three-point support, the support element corresponding to one support point of the three-point support.

8. The window-lifting device according to claim 1, wherein a longitudinal axis of the adjustment device is inclined with respect to a line perpendicular to the guide rail.

9. The window-lifting device according to claim 6, further comprising a carrier plate having cut-outs in a region of the retainer elements mounted to the carrier.

10. A window-lifting device, comprising:
guide rail means;
carrier means for connecting a window pane to a window lifter; and
adjusting means for changing an inclination of the window pane relative to the guide rail means about a swivel axis;
wherein the carrier means is movably supported directly on the guide rail means in a region of the swivel axis, the adjusting means changing an inclination of the carrier means relative to the guide rail means about the swivel axis to change the inclination of the window pane.

11. A motor-vehicle door, comprising:
a window pane;
a window lifter; and
a window-lifting device including:
at least one guide rail;
at least one carrier, the window pane connected to the window lifter by the carrier; and
an adjustment device adapted to change an inclination of the window pane relative to the guide rail about a swivel axis;
wherein the carrier is movably supported directly on the guide rail in a region of the swivel axis, the adjustment device adapted to change an inclination of the carrier relative to the guide rail about the swivel axis to change the inclination of the window pane.
